(19) United States
(12) Patent Application Publication
(10) Pub. No.: US 2025/0156716 A1
(43) Pub. Date: May 15, 2025

(54) TRAINING NEURAL NETWORKS USING LAYERWISE FISHER APPROXIMATIONS

(71) Applicant: Google LLC, Mountain View, CA (US)

(72) Inventors: Ehsan Amid, Mountain View, CA (US); Rohan Anil, San Francisco, CA (US)

(21) Appl. No.: 18/837,491

(22) PCT Filed: Feb. 10, 2023
(86) PCT No.: PCT/US2023/012853

§ 371 Date: Aug. 9, 2024

Related U.S. Application Data
(60) Provisional application No. 63/308,900, filed on Feb. 10, 2022.

(51) Int. Cl. G06N 3/084; G06F 7/78; G06F 17/16

(52) U.S. Cl. CPC G06N 3/084; G06F 7/78; G06F 17/16

(57) ABSTRACT

Methods, systems, and apparatus, including computer programs encoded on computer storage media, for training a neural network using layer-wise Fisher approximations.

### CROSS-REFERENCE TO RELATED APPLICATIONS

This application claims the benefit of priority under 35 U.S.C. § 119 to U.S. Provisional Application Ser. No. 63/308,900, filed Feb. 10, 2022, the entirety of which is incorporated herein by reference.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a neural network that processes network inputs to generate network outputs. In particular, the system described in this specification trains the neural network using layerwise Fisher approximations, so that the training process can benefit from the improvements associated with natural gradient descent (NGD) without requiring an additional backward pass through the neural network. In other words, the system uses layerwise Fisher approximations to improve the quality of the updates that are computed for the parameters of the layers of the neural network in a computationally efficient manner.

Particular embodiments of the subject matter described in this specification can be implemented so as to realize one or more of the following advantages.

Natural gradient descent (NGD) has shown remarkable utility for training deep neural networks. NGD corresponds to taking a gradient step in which the gradient is preconditioned using the Fisher Information Metric (FIM). Despite the efficacy of NGD, its applicability for DNNs is hindered partially due to the complexity of calculating the FIM. Specifically, calculating the FIM is generally computationally expensive for deep networks for two main reasons: 1) the true Fisher calculation requires sampling labels from the predictive distribution of the model and then performing a backward pass to calculate the gradients with respect to the weights of each layer (thus, doubling the number of backward passes relative to other training techniques that only require a single backward pass) and 2) the NGD step requires performing a matrix inverse which immediately becomes computationally formidable for layers with a large number of parameters.

While some practical approximations of the true FIM exist, the computational cost of the sampled gradients remains a source of significant overhead relative to other approaches because of the additional backward pass that is required.

The described techniques achieve the performance advantages of training using NGD while significantly reducing the computational overhead relative to conventional techniques. In particular, by approximating the Fisher by sampling from a predictive distribution that is local to each layer, the described techniques allow for updates to be computed locally for each layer, eliminating the need for performing the additional backward pass and significantly reducing the amount of processor cycles used and memory consumed in order to perform each training step. More specifically, because the updating operations performed to approximate the FIM are local to each layer, the described techniques are optimized for parallel processing across multiple hardware devices in order to reduce the computational overhead required to compute the approximations.

An example of computational benefits of the described techniques are shown in Table 1.

TABLE 1

| Algorithm | Memory | Computation |
|---|---|---|
| Adam | O(Πᵢdᵢ) | O(Πᵢdᵢ) |
| K-FAC | O(Σᵢdᵢ²) | O(bΣᵢdᵢ²) + O(Σᵢdᵢ³) + O(bΠᵢdᵢ) |
| Local K-FAC | O(Σᵢdᵢ²) | O(bΣᵢdᵢ²) + O(Σᵢdᵢ³) |

Table 1 compares the computational requirements of one implementation of the described techniques (“local K-FAC”) with a first order algorithm (“Adam”) and a second order algorithm (“K-FAC)” in terms of memory required and computation required, with O( ) representing Big O notation, the sum or product over i being a sum or product over the layers of the neural network, b being the batch size used for the training, and di being the dimensions of layer i.

As can be seen from Table 1, while the described techniques require similar memory to the second-order algorithms, the described techniques require a significantly smaller of computation due to not requiring a second backwards pass through the neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is a flow diagram of an example process for performing a training step during the training of the neural network.

FIG. 3 is a flow diagram of an example process for performing the updating operations.

Like reference numbers and designations in the various drawings indicate like elements.

### DETAILED DESCRIPTION

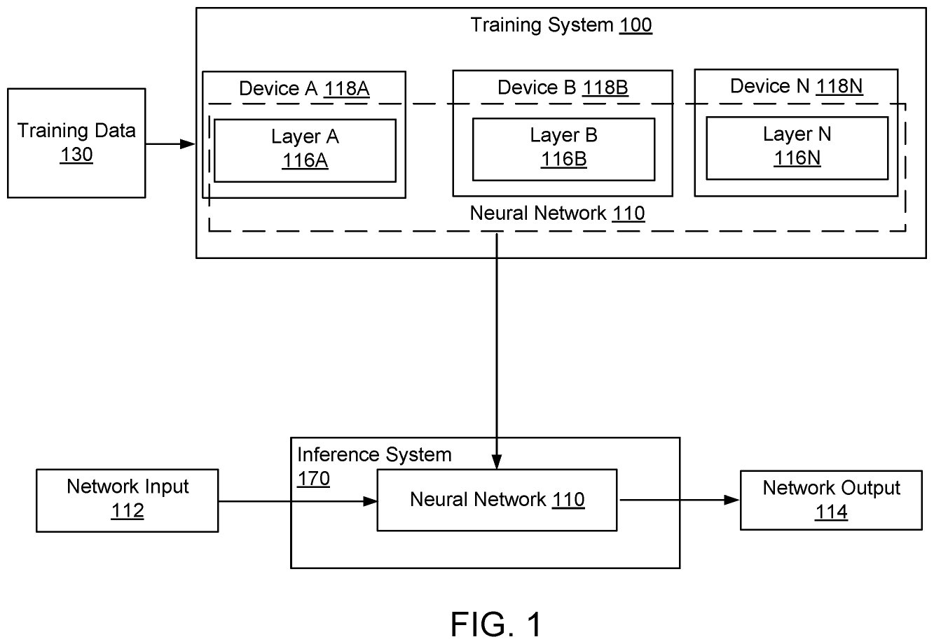

FIG. 1 shows an example training system 100. The training system 100 is an example of a system implemented as computer programs on one or more computers in one or more locations, in which the systems, components, and techniques described below can be implemented.

The system 100 trains a neural network 110 that is configured to perform a particular machine learning task on training data 130. That is, the neural network 110 is configured to process a network input 112 to generate a network output 114 for the network input 112 for the particular machine learning task.

The neural network 110 can be trained to perform any kind of machine learning task, i.e., can be configured to receive any kind of digital data input and to generate any kind of score, classification, or regression output based on the input.

In some cases, the neural network 110 is a neural network that is configured to perform an image processing task, i.e., receive an input image and to process the input image, i.e., process the intensity values of the pixels of the input image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network 110 are Internet resources (e.g., web pages), documents, or portions of documents or features extracted from Internet resources, documents, or portions of documents, the task can be to classify the resource or document, i.e., the output generated by the neural network 110 for a given Internet resource, document, or portion of a document may be a score for each of a set of topics, with each score representing an estimated likelihood that the Internet resource, document, or document portion is about the topic.

As another example, if the inputs to the neural network 110 are features of an impression context for a particular advertisement, the output generated by the neural network may be a score that represents an estimated likelihood that the particular advertisement will be clicked on.

As another example, if the inputs to the neural network 110 are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network 110 is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network 110 is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

The training data 130 includes a set of training inputs and, for each training input, a label. The label for a given training input specifies the network output that should be generated by performing the machine learning task on the given training input, i.e., is a target output that should be generated by the neural network 110 after training.

The neural network 110 can have any appropriate architecture that allows the neural network 110 to perform the particular machine learning task, i.e., to map network inputs of the type and dimensions required by the task to network outputs of the type and dimensions required by the task. That is, when the task is a classification task, the neural network 110 maps the input to the classification task to a set of scores, one for each possible class for the task. When the task is a regression task, the neural network 110 maps the input to the regression task to a set of regressed values, one for each value that needs to be generated in order to perform the regression task.

As one example, when the inputs are images, the neural network 110 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the neural network 110 can be a recurrent neural network, e.g., a long short-term memory (LSTM) or gated recurrent unit (GRU) based neural network, or a Transformer neural network.

As another example, the neural network can be feed-forward neural network, e.g., an MLP, that includes multiple fully-connected layers.

Generally, however, the neural network 110 includes multiple layers 116A-116N that each have respective weights.

In particular, each of the multiple layers 116A-N is configured to receive a layer input and apply the respective weights for the layer to the layer input to generate a pre-activation for the layer. How the layer 116A-N applies the weights to the layer input depends on the type of neural network layer. For example, a convolutional layer computes a convolution between the weights and the layer input. As another example, a fully-connected layer computes a product between the weights of the layer and the layer input.

Each of the multiple layers 116A-N is then configured to apply a transfer function of the layer to the pre-activation to generate a post-activation, i.e., the layer output of the layer, and then provide the post-activation to one or more other layers of the neural network that are configured to receive input from the layer according to the neural network architecture. The transfer function of any given layer is an element-wise non-linear function, and different layers can have different transfer functions. Examples of transfer functions include ReLU, Leaky ReLU, Tanh, sigmoid, and so on. Another example of a transfer function is the identity function, i.e., for a linear layer that does not have an activation function.

The neural network 110 can have additional layers and components that do not have weights, e.g., normalization layers, pooling layers, residual connections, softmax layers, logistic layers, and so on.

Thus, to train the neural network 110, the training system 100 repeatedly updates the weights of the multiple layers 116-N using the training data 130 at different training steps to minimize a task loss function. The task loss function can be any appropriate differentiable loss function that is appropriate for the particular task, i.e., that measures the quality of an output generated by the neural network for a given input relative to the label for the given input for the particular task. Examples of task loss functions include cross-entropy losses, squared error losses, negative log likelihood losses, and so on. In some cases, the task loss function may also include one or more additional terms, e.g., auxiliary loss terms, regularization terms, and so on, that do not depend on the label for the given input.

In particular, at each training step, the system 100 performs a forward pass and a backward pass through the neural network to determine layer inputs and layer outputs for each layer and to determine a gradient of the task loss function with respect to the weights of each of the layers.

The system 100 then performs a respective set of local updating operations for each layer to determine an update of the weights for the layer that depends on an approximation of the FIM for the layer.

That is, unlike conventional first-order techniques, the system 100 performs local update operations for each layer to incorporate an approximation of the FIM for the layer into the update of the weights for the layer.

Unlike conventional second-order techniques, these update operations are “local” and do not require communicating information between layers. In particular, the update operations do not require the system 100 to perform a second, computationally expensive backwards pass through the neural network in order to determine the approximation of the FIM.

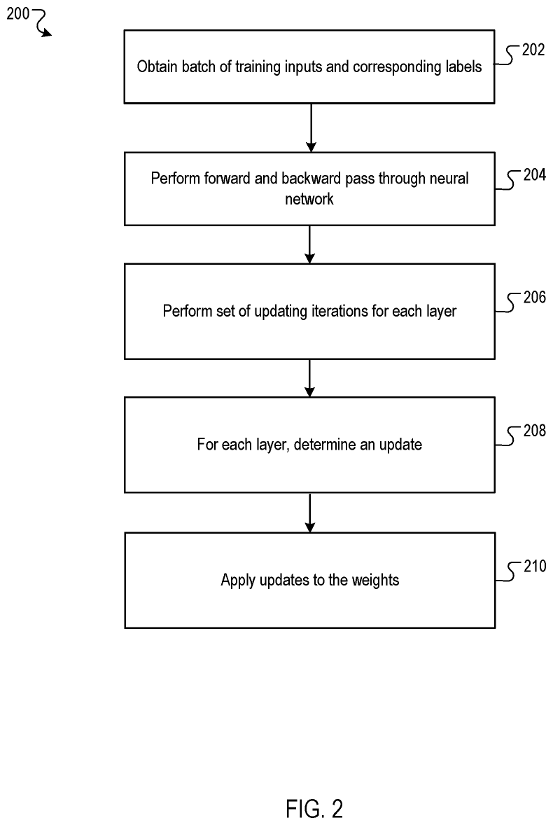

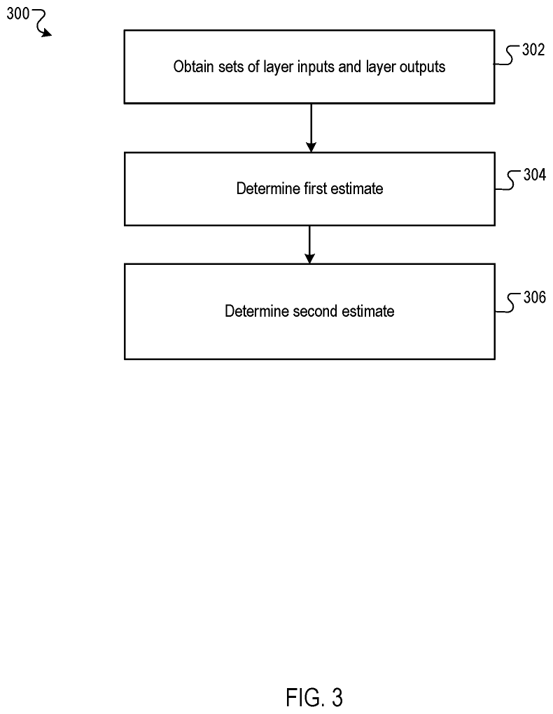

Performing these updating iterations is described in more detail below with reference to FIGS. 2 and 3.

In some implementations, the system 100 distributes the training of the neural network 100 across multiple devices.

In particular, the system 100 can distribute the training of the neural network 100 across multiple devices 118A-118N. Each device can be, e.g., a CPU, GPU, a TPU or other ASIC, an FPGA, or other computer hardware that is configured to perform the operations required to compute a layer output for at least one of the layers 116A-N and to compute gradients of the task loss function.

The system 100 can distribute the training of the neural network 100 in any of a variety of configuration. For example, as shown in FIG. 1, the system 100 can assign each of the layers 116A-116N to a different one of the devices 118A-118N. As another example, the system 100 can assign a different partition of the layers (that can include multiple layers) to each of the devices 118A-118N.

By distributing the training across devices, the system 100 can ensure that sufficient computational resources are available to perform the local updating operations in parallel for each of the layers 116A-116N at each training step. By performing the local updating operations in parallel, the system 100 realizes the advantages of the approximation of the FIM while minimizing the additional computational overhead required to perform multiple steps, i.e., relative to a single update step as is performed by conventional first-order optimizers. That is, the system optimizes the training scheme for parallel processing hardware in order to achieve the benefits of second-order optimization algorithms without the additional latency and computational overhead.

After training, the training system 100 or a different inference system 170 deploys the trained student neural network 110 on one or more computing devices to perform inference, i.e., to generate new network outputs 114 for the machine learning task for new network inputs 112.

FIG. 2 is a flow diagram of an example process 200 for performing a training iteration during the training of the neural network. For convenience, the process 200 will be described as being performed by a system of one or more computers located in one or more locations. For example, a training system, e.g., the training system 100 of FIG. 1A, appropriately programmed, can perform the process 200.

The system can repeatedly perform iterations of the process 200 to repeatedly update the network parameters until a termination criterion has been satisfied, e.g., until a threshold number of iterations of the process 200 have been performed, until a threshold amount of wall clock time has elapsed, or until the values of the network parameters have converged.

The system obtains a batch that includes one or more training inputs and a respective label for each training input (step 202). The system will generally obtain different training inputs at different iterations, e.g., by sampling a fixed number of inputs from a larger set of training data at each iteration. The label for each training input identifies a target output for the training input that should be generated by performing the particular machine learning task on the training input.

The system performs a forward pass through the neural network and a backward pass through the neural network (step 204). As a result of performing the forward and backward pass, the system determines: (i) a respective layer input to each neural network layer for each training input, (ii) a respective layer output for each neural network layer for each training input, and (iii) for each neural network layer, a respective gradient with respect to the set of weights of the neural network layer of a task loss function for the machine learning task.

As described above, the task loss function includes one or more terms that measure, for each training input, a training output for the training input generated by performing the forward pass through the neural network relative to the respective label for the training input.

The task loss function can be any appropriate loss function for the machine learning task. For example, the one or more terms can be cross entropy loss terms, mean squared error loss terms, negative log likelihood loss terms, and so on.

The task loss function can also include other terms, e.g., regularization terms, auxiliary loss terms, unsupervised learning loss terms, and so on, that do not depend on the labels for the training inputs.

In more detail, the system performs a forward pass through the neural network to generate a respective training output for each training input. As part of performing the forward pass, the system processes each training input through each layer of the neural network and, as a result, obtains the respective layer inputs and the respective layer inputs for each layer.

The system then performs the backward pass through the neural network to compute, through backpropagation, the respective gradients for each of the layers.

For each neural network layer, the system then updates the set of weights for the neural network layer by performing a set of updating operations (step 206).

In particular, the system performs the updating operations locally for each layer, i.e., without needing to propagate information between layers once the quantities from step 204 are computed.

More specifically, the system performs the updating operations for each layer to determine (i) a first estimate of a first expected self outer product of an input sampled from a distribution of layer inputs to the neural network layer and (ii) a second estimate of a second expected self outer product of a gradient of a local loss for the layer for a layer output sampled from a distribution of layer outputs of the neural network layer

The local loss for a given layer measures how close the current output of the layer is to a target output for the layer. The target output is defined by changing the current output slightly in a way that the final loss, i.e., the task loss described and below, is reduced if the target output is passed through the remaining layers of the network instead of the current output). Specifically, given current_output_at_layer_i and final loss (pass_through_network(current_output_at_layer_i), the target_output_at_layer_i is formed such that final_loss(pass_through_network(target_output_at_layer_i))<final_loss(pass_through_network(current_output_at_layer_i)).

In other words, the local loss measures, if the layers after the current layer i are fixed (i.e., layers i+1 up to L, the total number of layers in the network), how the current output of layer i needs to change in order to reduce the final loss.

A “self outer product” of a tensor is an outer product of a tensor with itself, i.e., the self outer product of a vector u is equal to the outer product of u and u. In other words, the system determines the first estimate by computing a combination of, for each layer input, a product between the layer input and a transpose of the layer input (where the layer input is represented as a column vector and the transpose is a row vector).

Performing the updating operations is described in more detail below with reference to FIG. 3.

The system then determines, for each layer, an update to the set of weights for the neural network layer from the first estimate, the second estimate, and the respective gradient of the task loss with respect to the set of weights for the neural network layer (step 208). More specifically, the system uses the first and second estimates as preconditioners for the gradient, i.e., to adjust the gradient before the gradient is used to compute the update to the weights. Thus, like NGD, the system takes a gradient step in which the gradient is preconditioned. Unlike NGD, the system uses the first and second estimates, which are determined locally for each layer, to precondition the gradient instead of the Fisher Information Metric (FIM). Thus, the first and second estimates serve as an approximation of the FIM that can be computed locally and without requiring another backward pass through the neural network.

As one example, the system can directly determine the update from the first and second estimates.

For example, the system can determine the update based on a product of (i) an inverse of a matrix representation of the second estimate, (ii) a matrix representation of the respective gradient, and (iii) an inverse of a matrix representation of the first estimate. As a particular example, the system can multiply the product by a step size value to determine the update.

That is, in this example, the update to a weight tensor Wₘ for a layer m in the neural network can be expressed as:

γL⁻¹∂_{W}_{ₘ}L(y,ŷ)R⁻¹,

where γ a step size constant that is greater than zero, L is the matrix representation of the second estimate, ∂_{W}_{ₘ}L(y, ŷ) is the respective gradient of the task loss with respect to the set of weights for the neural network layer, and R is the matrix representation of the first estimate.

As another example, the system can instead determine the update using moving averages of the first and second estimate.

That is, the system can maintain a first moving average of the first estimate across iterations of the process 200 and maintain a second moving average of the second estimate across iterations of the process 200.

The system can then update the first moving average using the first estimate, i.e., by computing a weighted sum between the first moving average and the first estimate, and update the second moving average using the second estimate, i.e., by computing a weighted sum between the second moving average and the second estimate.

The system can then determine the update to the set of weights for the neural network layer from the updated first moving average, the updated second moving average, and the respective gradient with respect to the task loss.

For example, the system can determine the update based on a product of (i) an inverse of a matrix representation of the updated second moving average, (ii) a matrix representation of the respective gradient, and (iii) an inverse of a matrix representation of the updated first moving average. As a particular example, the system can multiply the product by a step size value to determine the update.

That is, in this example, the update to a weight tensor Wₘ for a layer m in the neural network can be expressed as:

γL⁻¹∂_{W}_{ₘ}L(y,ŷ)R⁻¹,

where γ a step size constant that is greater than zero, L is the matrix representation of the updated second moving average, ∂_{W}_{ₘ}L(y, ŷ) is the respective gradient of the task loss with respect to the set of weights for the neural network layer, and R is the matrix representation of the updated first moving average.

The system can also use the first and second estimates to “pre-condition” the gradient in other ways, e.g., by applying Shampoo pre-conditioning using the first and second estimates.

The system can then update the weights for each layer by applying the update to the weights of layer, e.g., by subtracting the update from the weights (step 210).

Because the updating operations do not require any additional forward or backward passes through the neural network, the system can perform the updating operations, i.e., step 206 and, optionally, steps 208 and/or 210, in parallel for each of the layers. For example, the system can assign the updating operations for each layer to a respective hardware device from a plurality of hardware devices, e.g., CPUs, GPUs, TPUs, or other ASICs for accelerating machine learning workloads, or FPGAs, and then cause the assigned devices to perform the updating operations in parallel for the plurality of layers.

Thus, the system can improve the quality of the training, e.g., relative to conventional first-order methods that directly use the gradient to update the weights of each layer, with minimal additional overhead. Similarly, the system can attain similar or improved performance relative to KFAC or other second-order methods without performing the additional forward or backward passes that are required by those methods.

FIG. 3 is a flow diagram of an example process 300 for performing an update iteration for a layer of the neural network. For convenience, the process 300 will be described as being performed by a system of one or more computers located in one or more locations. For example, a training system, e.g., the training system 100 of FIG. 1A, appropriately programmed, can perform the process 300.

As described, the system can perform the process 300 for each of layers of the neural network. For example, the system can assign the updating operations for each layer to a respective hardware device from a plurality of hardware devices, e.g., CPUs, GPUs, TPUs, or other ASICs for accelerating machine learning workloads, or FPGAs, and then cause the assigned devices to perform the updating operations in parallel for the plurality of layers.

That is, in some implementations, the process 300 is performed in parallel by multiple hardware devices within the system, with each hardware device performing the process 300 for a different partition of the layers of the neural network.

The system obtains a set of layer inputs for the layer that includes a respective layer input to the neural network layer for each training input and a set of layer outputs for the layer that includes a respective layer output for each neural network layer for each training input (step 302).

The system determines, from the layer inputs to the neural network layer, a first estimate of a first expected self outer product of an input sampled from a distribution of layer inputs to the neural network layer (step 304).

In particular, the system can determine the first estimate by determining a combination of, for each layer input, a product between the layer input and a transpose of the layer input.

To determine the combination, the system can generate a matrix that has the layer inputs as the rows of the matrix.

The system can then compute a matrix product of (i) a transpose of that matrix and (ii) the matrix having the layer inputs as the rows of the matrix and then determine the first estimate by dividing each entry of the matrix product by a total number of training inputs in the batch.

The system determines, from the layer outputs for the neural network layer, a second estimate of a second expected self outer product of a gradient of a local loss for the layer for a layer output sampled from a distribution of layer outputs of the neural network layer (step 306).

The system computes this second estimate by sampling from a distribution that corresponds to, i.e., approximates, the distribution of layer outputs of the neural network layer.

In other words, the system determines the second estimate by computing a combination of, for each layer output, a product between (i) a difference for the layer output that is computed by sampling and (ii) a transpose of the difference for the layer output (where the difference is represented as a column vector and the transpose is a row vector).

More specifically, for each layer output, the system can sample a respective layer output (a “sampled layer output”) from a corresponding probability distribution for the neural network layer.

The corresponding probability distribution for the layer is one that approximates the density induced by the transfer function for the layer and will generally be different for different transfer functions.

For example, when the transfer function is a linear function, the probability distribution is a Gaussian distribution.

As another example, when the transfer function is a sigmoid function, the probability distribution is a Bernoulli distribution.

As another example, when the transfer function is a tanh function, because of the fact that the output post-activations are bounded in the range [−1, 1], the probability distribution can be a uniform envelope.

As another example, when the transfer function is a leaky ReLU, the probability distribution can be a Gaussian distribution centered, i.e., with a mean of, the layer output.

In the latter two cases, because there is no closed form for the distribution for tanh and Leaky ReLU, the system can sample from the corresponding proposal distribution, e.g., the uniform envelope or the Gaussian distribution, and then use rejection sampling to determine whether the samples are valid under the tanh or Leaky ReLU distributions. That is, the system can sample by using the uniform envelope or the Gaussian distribution described above as a proposal distribution in order to apply rejection sampling to the underlying distribution.

For each layer output, the system can then compute a difference between the layer output and the respective sampled layer output and determine a combination of, for each layer output, a product between the difference for the layer output and a transpose of the difference for the layer output.

For example, the system can generate a matrix that has the differences for the layer outputs as the rows of the matrix and then compute a matrix product of (i) the transpose of the matrix and (ii) the matrix. The system can then compute the second estimate by dividing each entry of the matrix product by a total number of training inputs in the batch.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a neural network having a plurality of neural network layers each having a respective set of weights to perform a machine learning task, the method comprising repeatedly performing training operations comprising:
obtaining a batch comprising one or more training inputs and a respective label for each training input;
performing a forward pass through the neural network and a backward pass through the neural network to determine:
(i) a respective layer input to each neural network layer for each training input,
(ii) a respective layer output for each neural network layer for each training input, and
(iii) for each neural network layer, a respective gradient with respect to the set of weights of the neural network layer of a task loss function for the machine learning task that includes one or more terms that measure, for each training input, a training output for the training input generated by performing the forward pass through the neural network relative to the respective label for the training input, and
for each neural network layer, updating the set of weights for the neural network layer by performing updating operations comprising:
determining, from the layer inputs to the neural network layer, a first estimate of a first expected self outer product of an input sampled from a distribution of layer inputs to the neural network layer;
determining, from the layer outputs for the neural network layer, a second estimate of a second expected self outer product of a gradient of a local loss for the layer for a layer output sampled from a distribution of layer outputs of the neural network layer;
determining an update to the set of weights for the neural network layer from the first estimate, the second estimate, and the respective gradient with respect to the task loss; and
updating the set of weights by applying the update to the set of weights.

2. The method of claim 1, wherein the updating operations are performed in parallel for each of the plurality of neural network layers.

3. The method of claim 2, wherein the updating operations for each of the neural network layers are assigned to and performed on a respective hardware device.

4. The method of claim 1, wherein determining an update to the set of weights for the neural network layer from the first estimate, the second estimate, and the respective gradient with respect to the task loss comprises:
updating a first moving average using the first estimate;
updating a second moving average using the second estimate; and
determining the update to the set of weights for the neural network layer from the updated first moving average, the updated second moving average, and the respective gradient with respect to the task loss.

5. The method of claim 4, wherein determining the update to the set of weights comprises:
determining a product of (i) an inverse of a matrix representation of the updated second moving average, (ii) a matrix representation of the respective gradient, and (iii) an inverse of a matrix representation of the updated first moving average.

6. The method of claim 5, wherein determining the update further comprises multiplying the product by a step size value.

7. The method of claim 1, wherein applying the update comprises subtracting the update from the weights.

8. The method of claim 1, wherein determining, from the layer inputs to the neural network layer, a first estimate of a first expected self outer product of an input sampled from a distribution of layer inputs to the neural network layer comprises:
determining a combination of, for each layer input, a product between the layer input and a transpose of the layer input.

9. The method of claim 8, wherein determining a combination of, for each layer input, a product between the layer input and a transpose of the layer input comprises:
determining a matrix product of (i) a transpose of a matrix having the layer inputs as the rows of the matrix and (ii) the matrix having the layer inputs as the rows of the matrix.

10. The method of claim 9, wherein determining a combination of, for each layer input, a product between the layer input and a transpose of the layer input further comprises:
dividing each entry of the matrix product by a total number of training inputs in the batch.

11. The method of claim 1, wherein determining, from the layer outputs for the neural network layer, a second estimate of a second expected self outer product of a gradient of a local loss for the layer for a layer output sampled from a distribution of layer outputs of the neural network layer comprises:
for each layer output, sampling a respective layer output from a corresponding probability distribution for the neural network layer;
for each layer output, computing a difference between the layer output and the respective sampled layer output; and
determining a combination of, for each layer output, a product between the difference for the layer output and a transpose of the difference for the layer output.

12. The method of claim 11, wherein sampling from a corresponding probability distribution approximates sampling from a density induced by the transfer function for the layer.

13. The method of claim 11, wherein for each layer output, sampling a respective layer output from a corresponding probability distribution for the neural network layer comprises sampling with a mean of the corresponding probability distribution set to be equal to the layer output.

14. The method of claim 11, wherein determining a combination of, for each layer output, a product between the difference for the layer output and a transpose of the difference for the layer output comprises:
determining a matrix product of (i) a transpose of a matrix having the differences for the layer outputs as the rows of the matrix and (ii) the matrix having the differences for the layer outputs as the rows of the matrix.

15. The method of claim 14, wherein determining a combination of, for each layer output, a product between the difference for the layer output and a transpose of the difference for the layer output further comprises:
dividing each entry of the matrix product by a total number of training inputs in the batch.

16. The method of claim 4, wherein updating a first moving average using the first estimate comprises computing a weighted sum between the first moving average and the first estimate, and wherein updating a second moving average using the second estimate comprises computing a weighted sum between the second moving average and the second estimate.

17. A system comprising one or more computers and one or more storage devices storing instructions that are operable, when executed by the one or more computers, to cause the one or more computers to perform the operations for training a neural network having a plurality of neural network layers each having a respective set of weights to perform a machine learning task, the method comprising repeatedly performing training operations comprising:
obtaining a batch comprising one or more training inputs and a respective label for each training input;
performing a forward pass through the neural network and a backward pass through the neural network to determine:
(i) a respective layer input to each neural network layer for each training input,
(ii) a respective layer output for each neural network layer for each training input, and
(iii) for each neural network layer, a respective gradient with respect to the set of weights of the neural network layer of a task loss function for the machine learning task that includes one or more terms that measure, for each training input, a training output for the training input generated by performing the forward pass through the neural network relative to the respective label for the training input, and
for each neural network layer, updating the set of weights for the neural network layer by performing updating operations comprising:
determining, from the layer inputs to the neural network layer, a first estimate of a first expected self outer product of an input sampled from a distribution of layer inputs to the neural network layer;
determining, from the layer outputs for the neural network layer, a second estimate of a second expected self outer product of a gradient of a local loss for the layer for a layer output sampled from a distribution of layer outputs of the neural network layer;
determining an update to the set of weights for the neural network layer from the first estimate, the second estimate, and the respective gradient with respect to the task loss; and
updating the set of weights by applying the update to the set of weights.

18. One or more non-transitory computer storage media encoded with instructions that, when executed by one or more computers, cause the one or more computers to perform the operations for training a neural network having a plurality of neural network layers each having a respective set of weights to perform a machine learning task, the method comprising repeatedly performing training operations comprising:
obtaining a batch comprising one or more training inputs and a respective label for each training input;
performing a forward pass through the neural network and a backward pass through the neural network to determine:
(i) a respective layer input to each neural network layer for each training input,
(ii) a respective layer output for each neural network layer for each training input, and
(iii) for each neural network layer, a respective gradient with respect to the set of weights of the neural network layer of a task loss function for the machine learning task that includes one or more terms that measure, for each training input, a training output for the training input generated by performing the forward pass through the neural network relative to the respective label for the training input, and
for each neural network layer, updating the set of weights for the neural network layer by performing updating operations comprising:
determining, from the layer inputs to the neural network layer, a first estimate of a first expected self outer product of an input sampled from a distribution of layer inputs to the neural network layer;
determining, from the layer outputs for the neural network layer, a second estimate of a second expected self outer product of a gradient of a local loss for the layer for a layer output sampled from a distribution of layer outputs of the neural network layer;
determining an update to the set of weights for the neural network layer from the first estimate, the second estimate, and the respective gradient with respect to the task loss; and
updating the set of weights by applying the update to the set of weights.

19. The system of claim 17, wherein the updating operations are performed in parallel for each of the plurality of neural network layers.

20. The system of claim 19, wherein the updating operations for each of the neural network layers are assigned to and performed on a respective hardware device.
